(19) United States
(12) Patent Application Publication
(10) Pub. No.: US 2005/0118965 A1
(43) Pub. Date: Jun. 2, 2005

(54) Signal transmitter

(75) Inventors: Mitsuru Tanabe, Katano-shi (JP); Koichiro Tanaka, Takarazuka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/997,892

(22) Filed: Nov. 29, 2004

(30) Foreign Application Priority Data
Dec. 2, 2003 (JP) 2003-402615

(51) Int. Cl. H04B 1/04; H01Q 11/12

(52) U.S. Cl. 455/127.1; 455/126

(57) ABSTRACT

An amplitude component and a phase component among modulating signals are supplied into a radio frequency wave input terminal and a power supply terminal of a radio frequency power amplifier, respectively, and an original modulated wave is obtained from an output of the radio frequency power amplifier. The output of the radio frequency power amplifier is detected by an output detecting section, correction data to a detection voltage closest to the detection voltage among correction datatables which have been measured in various temperature environments and stored in advance are selected by a selector, and correction of an amplitude component and a phase component is performed by phase-amplitude correction means. Thereby enabling EER operation without spectrum degradation.

### BACKGROUND OF THE INVENTION

1. Field of the Invention

The present invention is related to a wireless transmitter.

2. Description of the Prior Art

Linear operation is generally required for a radio frequency power amplifier used for transmitting signal power to an antenna when a signal modulation method that accompanies amplitude modulation is used, especially when a M-ary modulation method such as a QAM(Quadrature Amplitude Modulation) method is used. For this reason, class A or class AB operation has been conventionally used for a radio frequency power amplifier.

However, on the other hand, communication technologies that use multiple carriers such as an OFDM (Orthogonal Frequency Division Multiplex) technology have become commonly used in accordance with the development of broadband communications. Consequently, in such a case, high operational efficiency cannot be expected any more for a conventional radio frequency power amplifier that is operated at class A or class AB. More precisely, a large signal power may be generated instantly and at random in the OFDM scheme that allows sub-carrier spectrum overlaps. It therefore leads to a large peak to average power ratio (PAPR) between the average power and the peak power of modulated signal for the amplifier operation. For this reason, a large DC power should always be maintained in the amplifier so that it may linearly amplify a peak power considerably larger than the average power. As a result, the DC power given by multiplication of the current and a voltage difference between a peak voltage that ensures the peak power and a average voltage that ensures the average power will almost be wasted as heat, except for a time period during which the peak power is outputted. This means that the power supply efficiency of the amplifier will be severely lowered.

For a portable radio system that uses, for example a battery as a power supply, the above situation is practically unacceptable since its available time of continuous operation becomes short. The Envelope Elimination and Restoration (EER) method that is known as Kahn Technique has proposed to solve such a problem as is explained above (see, for example U.S. Pat. No. 6,256,482 (FIG. 6 on Drawings Page 3)).

FIG. 6 is a block diagram showing a rough outline of the EER method. In FIG. 6, an OFDM signal generated by OFDM signal generating means 601 is separated into a phase component and an amplitude component by phase-amplitude separation means 602. In more detail, the complex vector wave with I and Q components of the OFDM signal generated by the OFDM signal generating means 601 is separated into the amplitude component of (I²+Q²)^{1/2} and the phase component of θ=tan⁻¹(Q/I). The phase component is actually expressed as a pair of a real part and an imaginary part of a complex conjugate number exp(jθ) so that it may be suited for a quadrature modulator 604 that will be explained later as an appropriate input signal. The phase component is modulated by the quadrature modulator 604 and then supplied to an input signal terminal RFin of a radio frequency power amplifier 605 as a radio frequency input signal power. The amplitude component is supplied to a power supply input terminal VDD of the radio frequency power amplifier 605 via a DC-DC converter 603.

As an example of OFDM signals, an OFDM signal specified by IEEE standard 802.11a for wireless LAN applications is included. In order to satisfy the Error Vector Magnitude (EVM) specification of 5.6% specified by the standard, the radio frequency power amplifier 605 must operate at 7 dB lower than its maximum saturation power level (at the back-off of 7 dB), in the example. It means that the radio frequency power amplifier 605 utilizes only 20% of its output power capability.

If the amplifier operates at class A, the maximum drain efficiency (the ratio of the output radio frequency signal power and the input DC power) of the amplifier is 50%, and its power consumption is constant regardless of its output radio frequency signal power. As a result, when an OFDM modulated signal in this example is supplied to the amplifier, its power efficiency will be 10% at the maximum. As explained above, an ordinary class A radio frequency power amplifier cannot attain high power efficiency.

In order to solve the problem, in the EER method, the phase modulation component with a constant envelope amplitude is applied to the signal input terminal RFin of the radio frequency power amplifier 605, and the amplitude component is applied to the power supply input terminal VDD of the radio frequency power amplifier 605. Amplitude information and phase information are then multiplied at an output terminal RFout of the radio frequency power amplifier 605, so that the original OFDM vector signal will be recovered.

By using such a configuration explained above, the radio frequency power amplifier 605 can operate at the back-off of 0 dB, thereby making it possible to realize the maximum drain efficiency of nearly 50%, when it operates at, for example class A. An amplifier which is operated at a non-linear class of operation such as class B, C, E, or F may also be used. Since the drain efficiency of such an amplifier is larger than the drain efficiency of the class A operating amplifier, higher drain efficiency can be expected for the amplifier operating at one of these classes.

Generally, in the EER method, when deploying the radio frequency power amplifier 605 operating at one of the especially high efficiency classes mentioned above, it is necessary to apply a correction to the amplitude component and the phase component of the input signal so that the radio frequency power amplifier 605 may produce a correct output signal. In a distortion-compensation type amplifier that realizes aforementioned conditions, the output signal of a radio frequency power amplifier 704 is fed back to the input side by down-converting a frequency of an output signal into an intermediate frequency (IF) by using a frequency converter 705 as shown in FIG. 7. After the frequency conversion, the I and Q components of the fed-back signal are detected by a quadrature detector 706. A compensation value updating section 707 has optimized compensation values based on the detected I and Q components (IQ signals) of the fed-back signal and has then supplied it to a compensation value table 708 (see, for example Japanese Laid-Open Patent Application Publication No. 2001-320246 (page 5, FIG. 1 and FIG. 3)). Incidentally, in FIG. 7, symbol 701 represents signal generating means. Symbol 702 represents a signal adjusting section that adjusts an input signal provided by signal generating means 701 based on compensation values stored in a compensation value table 708. Symbol 703 represents a quadrature modulator.

However, since a compensation value optimization requires a complicated circuit and additional power consumption is also required for the feed back loop that has no relation to signal power amplification, it is difficult to realize a signal transmitter with low power consumption by using the composition of FIG. 7. In view of this problem, in order to avoid such circuit complexity, following method has been proposed. That is, as shown in FIG. 8, a temperature measuring section 805 is equipped nearby a radio frequency power amplifier 804. In addition, a compensation value table group 807 including a plurality of types of compensation value table that store in advance the compensation values for compensating waveform distortion of the signal amplified by the radio frequency power amplifier 804. A proper compensation table is selected among the compensation value table group 807 by a selector 806 based on the temperature status of the radio frequency power amplifier 804, and the signal generated by signal generating means 801 is then compensated by a signal adjusting section 802 based on the selected compensation value table. The compensated signal is then supplied to the radio frequency power amplifier 804 via a quadrature modulator 803.

However, when correcting the tables according to the ambient temperature of the radio frequency power amplifier 804, the ambient temperature is easily affected by the operation environment of the amplifier. This means that the measured temperature does not always represent the real temperature within a channel of the radio frequency power amplifier 804.

In the EER method in particular, when the signal is separated into the amplitude component and the phase component, since bandwidth limitations of the D-A converter (DAC) and the quadrature modulator is further added thereto, there is a tendency that an alternative adjacent channel power ratio especially is generally deteriorated as compared with a spectrum when performing class A linear operation. Imperfect distortion compensation cannot be allowed in the EER method since it further increases the alternative adjacent channel power ratio.

Accordingly, although it is necessary to reflect the radio frequency amplifier output signal to the correction, complicated processing and circuits used for the purpose as shown in the second prior art hinder an improvement in power efficiency of the amplifier, and even offset an improvement effect by the EER method, especially when the EER method is used for improvement in the signal transmitter power efficiency.

### SUMMARY OF THE INVENTION

The object of the invention is to provide a signal transmitter that can compensate for thermal characteristics of a radio frequency power amplifier efficiently and correctly.

In order to attain above object, a signal transmitter of a first invention comprises radio frequency (RF) power coupling means of taking out an RF power proportional to an output power of the radio frequency power amplifier to which a modulated signal is supplied at an output of the radio frequency power amplifier, and means of detecting an output voltage of the RF power coupling means. Moreover, it comprises storage means of recording a correction datatable for applying a change to the modulated wave signal supplied into the radio frequency amplifier corresponding to an output result of the above means of detecting the output voltage, and means of applying a change to the modulated wave signal supplied into the radio frequency power amplifier with reference to corresponding correction data from the storage means according to the output result of the means of detecting the output voltage.

According to this configuration, since the output power of the radio frequency power amplifier is detected, it is possible to correctly detect the channel temperature of the radio frequency power amplifier. Accordingly, a correction is carried out correctly. Additionally, a simple configuration does not allow an increase in power consumption. Hence, a correct compensation of the temperature characteristics of the amplifier can be carried out while maintaining high efficiency of the signal transmitter.

Hereafter, description will be made in detail. Whereas the ambient temperature of the radio frequency power amplifier is estimated in the prior art, according to the signal transmitter of the first invention, since the output power of the radio frequency power amplifier is detected, it is possible to correctly detect the channel temperature of the radio frequency power amplifier. Consequently, a correction is carried out correctly.

Also in the other prior art, the output signal of the high output power amplifier is subjected to a frequency conversion and then a quadrature detection, and the compensation value table is updated by resultant I and Q data (IQ data). As opposed to this, according to the signal transmitter of the first invention, the output voltage is detected, so that a configuration is simple and an increase in power consumption will be suppressed. Hence, a correct compensation of the temperature characteristics of the amplifier can be carried out while maintaining high efficiency of the signal transmitter.

Moreover, in order to achieve the above object, a signal transmitter of a second invention comprises modulated wave signal generating means of generating at least a modulated wave signal, phase-amplitude separation means of separating the modulated wave signal supplied from the modulated wave signal generating means into a phase component and an amplitude component as expressed on a polar coordinate. It also comprises a constant voltage source, and DC-DC conversion means into which the amplitude component and an output voltage of the constant voltage source are supplied to perform a voltage conversion of the voltage of the constant voltage source to a voltage proportional to the amplitude component. It further comprises a radio frequency power amplifier which supplies the phase component into a signal input terminal thereof, supplies the output of the DC-DC conversion means into a power supply terminal thereof, and produces a resultant modulated wave which is obtained by multiplying the amplitude component by the phase component.

In addition to the above configuration, it comprises RF power coupling means of taking out an RF power proportional to an output power of the radio frequency power amplifier at an output of the radio frequency power amplifier, and means of detecting an output voltage of the RF power coupling means. It still further comprises storage means of recording a correction datatable for applying a change to the amplitude component and the phase component supplied into the radio frequency amplifier corresponding to an output result of the means of detecting the output voltage, and means of applying a change to an output of the phase-amplitude separation means with reference to corresponding correction data from the storage means according to an output result of the means of detecting the output voltage.

According to this configuration, since the output power of the radio frequency power amplifier is detected, it is possible to correctly detect the channel temperature of the radio frequency power amplifier, and since a configuration is simple, an increase in power consumption will be suppressed, thereby making it possible to correctly compensate the temperature characteristics while maintaining highly efficiency of the signal transmitter using the EER method.

Hereafter, description will be made in detail. Whereas the ambient temperature of the radio frequency power amplifier is estimated in the prior art, according to the signal transmitter of the second invention, since the output power of the radio frequency power amplifier is detected, it is possible to correctly detect the channel temperature of the radio frequency power amplifier. Consequently, a correction is carried out correctly.

In the other prior art, the output signal of the high output power amplifier is subjected to a frequency conversion and then a quadrature detection, and the compensation value table is updated by using the I and Q data (IQ data) obtained by quadrature detection. As opposed to this, according to the signal transmitter of the second invention, since a configuration for detecting the output power amplitude is simple, an increase in power consumption will be suppressed. Hence, a correct compensation of the temperature characteristics of the amplifier can be carried out while maintaining high efficiency of the signal transmitter. Additionally, a temperature correction can be performed without spectral degradation in the EER method having few spectrum mask margin.

In the signal transmitter of the above second invention, it is preferable to have frequency conversion means between the radio frequency power amplifier and an output of the phase component of the phase-amplitude separation means.

Generally, since the operating bandwidth of the phase-amplitude separation means (including DAC) is hundreds of MHz at most, when the carrier frequency exceeds a GHz order, it cannot manage this frequency order. However, according to this configuration, by using a quadrature modulator or the like which is, for example frequency converting means, it becomes easily possible to upconvert the carrier frequency into the GHz band or the like.

### BRIEF DESCRIPTION OF THE DRAWINGS

FIG. 1 is a block diagram showing a configuration of a signal transmitter of a first embodiment of the present invention;

FIG. 2 is a flow chart showing a flow of a process of the signal transmitter of the first embodiment of the present invention;

FIG. 3 is a block diagram showing a configuration of a signal transmitter of a second embodiment of the present invention;

FIG. 4 is a view showing a transmission signal format of WLAN802.11a;

FIG. 5 is a flow chart showing a flow of a process of the signal transmitter of the second embodiment of the present invention;

FIG. 6 is a block diagram showing a configuration of a signal transmitter of a first prior art;

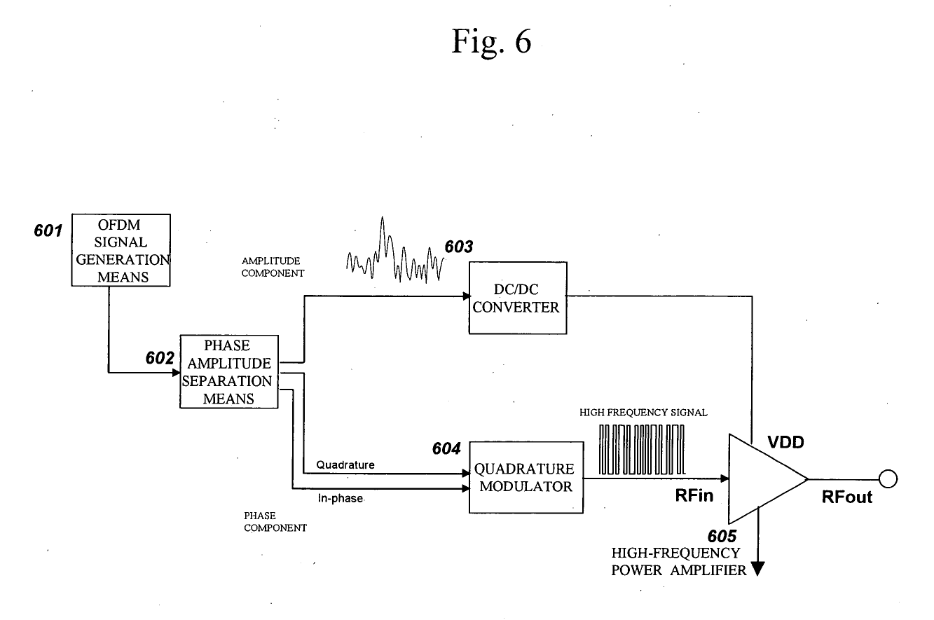

FIG. 7 is a block diagram showing a configuration of a signal transmitter of a second prior art; and

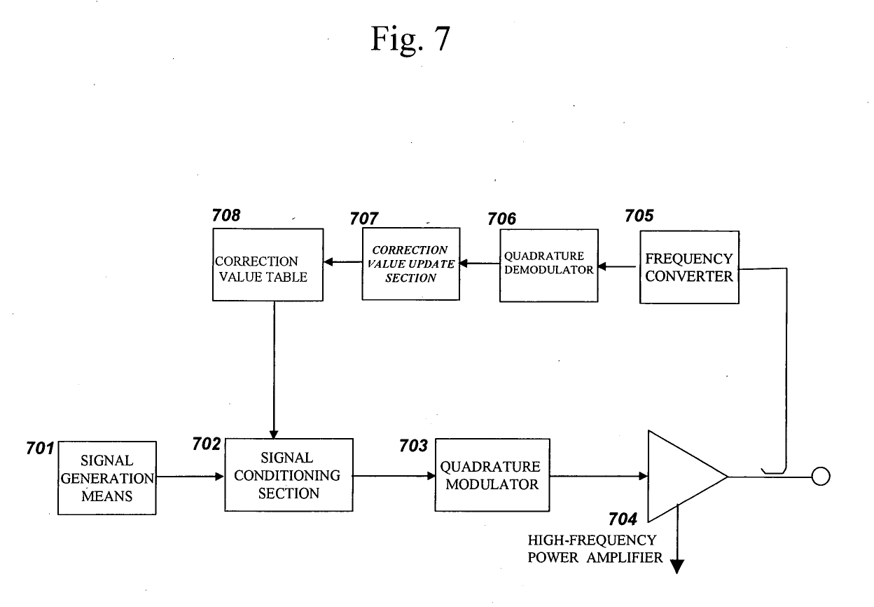

FIG. 8 is a block diagram showing a configuration of a signal transmitter of a third prior art.

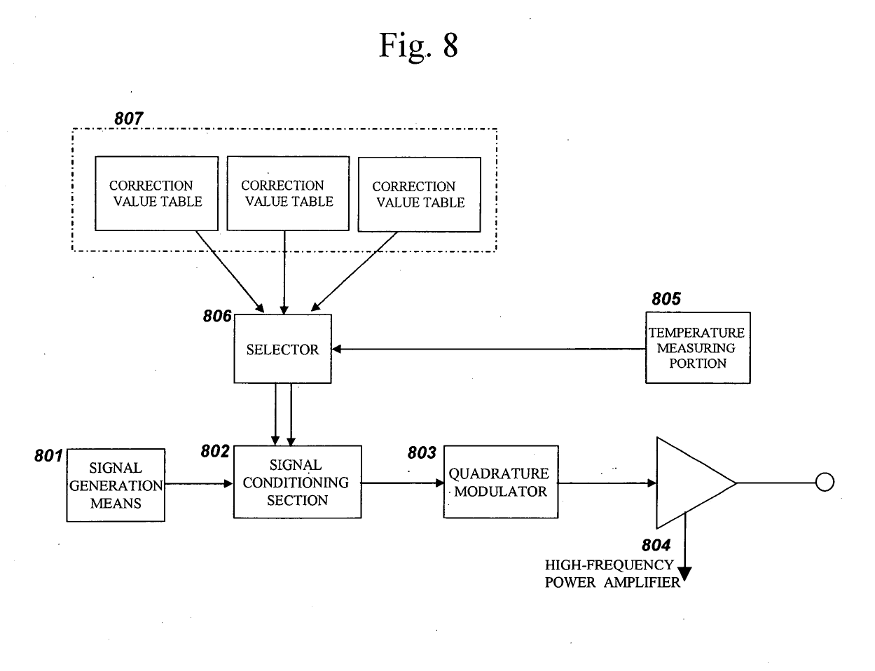

### DETAILED DESCRIPTION OF THE PREFERRED EMBODIMENTS

### First Embodiment

Hereafter, referring to the drawings, description will be made of embodiments according to the present invention. In this embodiment, QPSK (Quadrature Phase Shift Keying) is considered as a modulated wave. The QPSK method is a four-ary digital modulation scheme that maps an input digital signal onto X-Y coordinates by a vector synthesis of an In-Phase signal component (I) that has the same vector direction as an X-axis and a Quadrature signal component (Q) that is shifted by 90 degrees from the In-Phase signal component and has the same vector direction as a Y-axis.

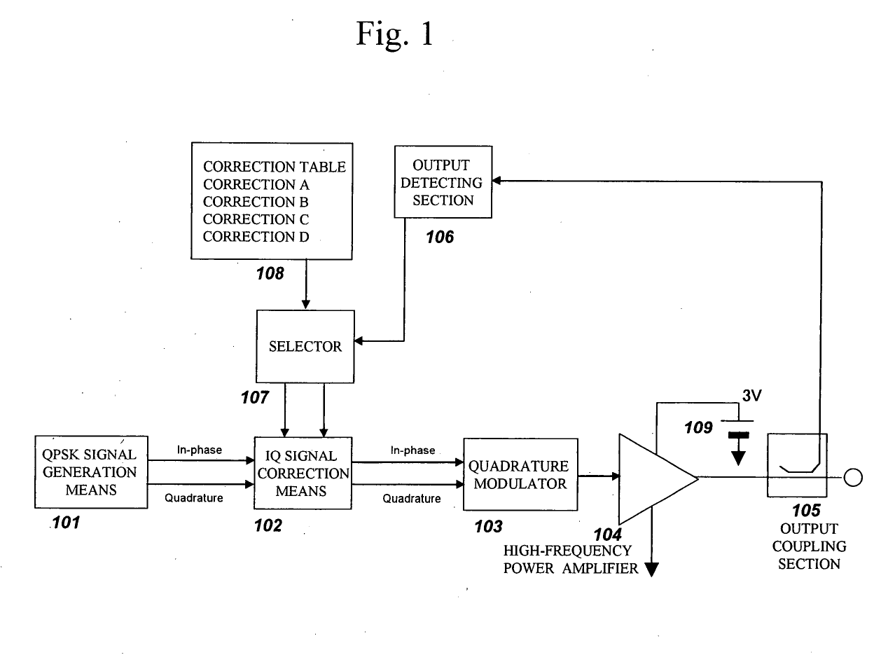

FIG. 1 is shows a block diagram of a signal transmitter of a first embodiment of the present invention. As shown in FIG. 1, this signal transmitter comprises QPSK signal generating means 101, IQ signal correction means 102, a quadrature modulator 103, a radio frequency power amplifier 104, an output coupling section 105, an output detecting section 106, a selector 107, a correction table 108, and a power supply 109.

The above QPSK signal generating means 101 generates a QPSK signal, and corresponds to modulated wave signal generating means of generating a modulated wave signal.

The selector 107 selects from the correction table 108 correction table data corresponding to an output power level of the radio frequency power amplifier 104. The configuration is as follows, for example. That is, an analog voltage supplied from the output detecting section 106 is digitizes by an A/D converter integrated in the selector 107. A digitized voltage is then compared with respective voltage data at the time of obtaining a plurality of correction tables which are included inside the selector 107. An address of the correction table 108 corresponding to a voltage data closest to the digitized voltage is then specified.

Alternatively, the analog voltage from the output detecting section 106 is compared with a plurality of voltage levels at the time of obtaining the correction table by a plurality of comparators. An address of the correction table 108 is then specified according to output patterns of a plurality of comparator outputs.

The correction table 108 supplies one of correction data sequences A through D represented by correction A through D by addressing from the selector 107. The correction data sequences A through D are determined as follows, for example.

Symbol A is a correction data sequence obtained as a result of evaluation in an ambient (room) temperature, symbol B is a correction data sequence obtained as a result of evaluation at the highest temperature specified in an absolute rating, symbol C is a correction data sequence obtained as a result of evaluation at the lowest temperature specified in the absolute rating, and symbol D is a correction data sequence obtained as a result of evaluation at a temperature between the absolute rating temperature and the ambient temperature.

Each of the correction data sequences A through D records a supply voltage which should be supplied to the radio frequency power amplifier 104 and a phase rotation which should be supplied to the phase component for a signal amplitude which is desired to be produced from the radio frequency power amplifier 104. Ideally, in the radio frequency power amplifier 104, an output signal amplitude may perfectly be proportional to the supply voltage, and even when the supply voltage is changed, a phase difference between an output signal and an input signal may be constant. However, since it will not actually happen, it is required to correct the supply voltage and the phase of the input signal for the signal amplitude which is desired to be produced.

The IQ signal correction means 102 receives an output from the QPSK signal generating means 101, namely as an amplitude and a phase of a signal which is desired to be produced from the radio frequency power amplifier 104, it obtains an output of a correction result of an IQ signal corrected by an optimum correction table sequence of the correction table 108 which is selected by the selector 107.

The quadrature modulator 103 performs a frequency conversion of a phase component supplied from the IQ signal correction means 102 and obtains an output of an IQ modulated wave.

The output coupling section 105 couples an RF power proportional to the output power of the radio frequency power amplifier 104 (for example, 10 dB coupling) to supply to the output detecting section 106.

In the output detecting section 106, a circuit which is composed of, for example a diode and a smoothing capacitor detects an envelope of the RF power proportional to the output power of the radio frequency power amplifier 104.

The radio frequency power amplifiers 104 may be operated at, for example class F, and supplies a modulated wave signal supplied from the quadrature modulator 103 into a signal input terminal and performs a desired power amplification to produce it.

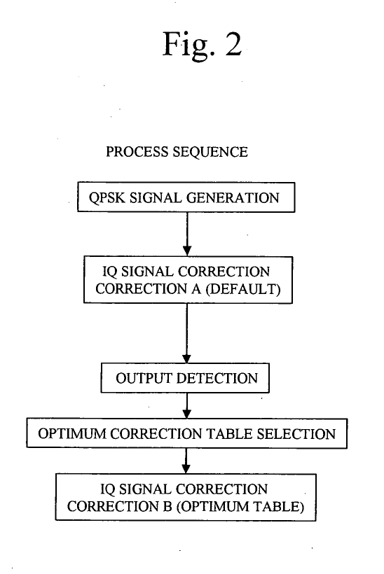

Hereinafter, description will be made of the operation using FIG. 2.

Description will be made of a process sequence using FIG. 2. When receiving a burst SEND statement from a Media Access Control Block (MAC), the QPSK signal generating means 101 supplies the IQ signal of QPSK. The supplied IQ signal of QPSK is corrected based on the correction data sequence A at the ambient temperature as a default in the IQ signal correction means 102. A corrected IQ signal is modulated by the quadrature modulator 103 and is supplied into a signal input terminal of the radio frequency power amplifier 104 as the IQ modulated wave signal. The radio frequency power amplifier 104 performs a desired power amplification to produce the IQ modulated wave signal. The produced IQ modulated wave signal is supplied into the output coupling section 105, so that a small signal, for example smaller by b 10 dB, proportional to the output power of the radio frequency power amplifier 104 is taken out from the output coupling section 105.

In the output detecting section 106, the RF power taken out by the output coupling section 105 is rectified by a diode and is then smoothed by a smoothing capacitor to be supplied as an average voltage. The average voltage taken out by the output detecting section 106 is compared with output average voltages measured at various environmental temperatures of the radio frequency power amplifier 104 in advance inside the selector 107. A correction table at an environmental temperature corresponding to an output average voltage closest to the average voltage taken out by the output detecting section 106, for example the correction B is then selected from the correction table 108. These processes are performed within an allowable range of a preamble signal which exists, for example in an early stage of a burst, and the correction data selected in the early stage are used during subsequent burst intervals.

According to a configuration described above, in the first embodiment, since the table data is selected by using the output of the radio frequency power amplifier 104, a channel temperature in operation of the radio frequency power amplifier 104 can be reflected correctly. Thereby making it possible to perform the correction of the radio frequency power amplifier 104 correctly. Moreover, since quadrature detection is not used for the output detecting section 106, a correction circuit and an algorithm can be simplified, thereby making it possible to achieve reduction in power consumption.

### Second Embodiment

Hereafter, referring to the drawings, description will be made of a second embodiment according to the present invention. In this embodiment, an OFDM modulated wave signal is considered as the modulated wave signal. As a system using OFDM, it includes a wireless LAN system of IEEE802.11a specification, for example. In a wireless LAN system, respective 52 subcarriers which perpendicularly intersect to each other are modulated using, for example 64 QAM technology, and respective modulated subcarriers are transformed by using a inverse Fourier transform scheme and are then multiplexed to generate an OFDM modulated signal. The 52 subcarriers are separated to each other by 312.5 kHz, respectively, and occupy a bandwidth of 52×312.5=16.25 MHz.

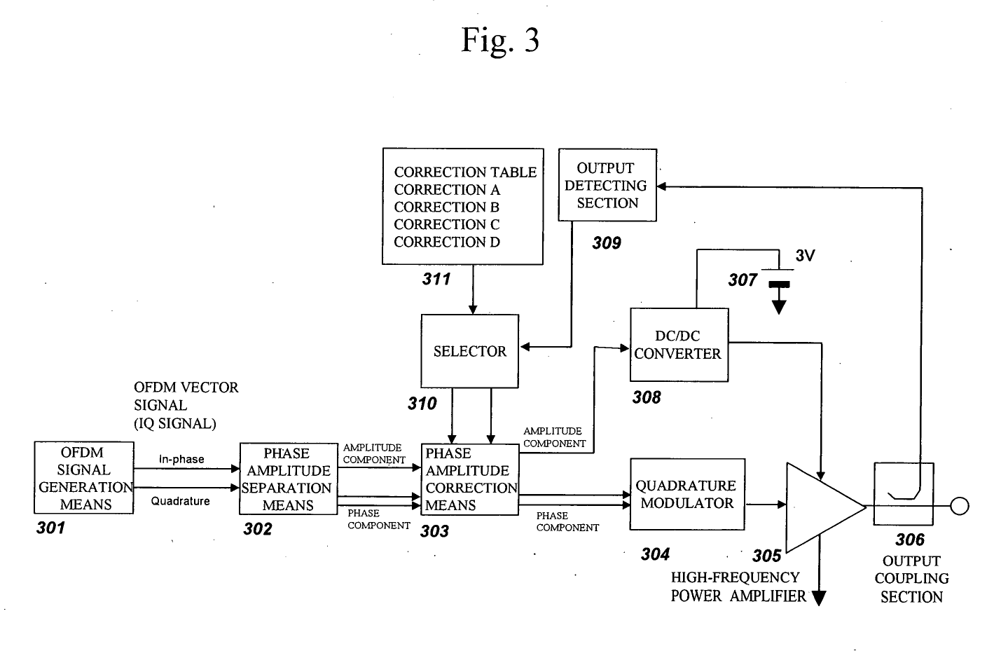

FIG. 3 shows a block diagram of a signal transmitter for achieving an EER method according to the embodiment of the present invention. As shown in FIG. 3, this signal transmitter comprises OFDM signal generating means 301, phase-amplitude separation means 302, phase-amplitude correction means 303, a quadrature modulator 304, a radio frequency power amplifier 305, an output coupling section 306, an output detecting section 309, a correction table 311, a selector 310, a DC-DC converter 308, and a power supply 307.

The above OFDM signal generating means 301 generates an OFDM signal and corresponds to modulated wave signal generating means of generating a modulated wave signal.

The phase-amplitude separation means 302 separates the OFDM modulated wave signal (OFDM vector signal, namely IQ signal) generated by the OFDM signal generating means 301 into a phase component and an amplitude component.

The selector 310 selects from the correction table 311 correction table data corresponding to an output power level of the radio frequency power amplifier 305. The configuration is as follows, for example. That is, an analog voltage supplied from the output detecting section 309 is digitizes by an A/D converter integrated in the selector 310. A digitized voltage is then compared with respective voltage data at the time of obtaining a plurality of correction tables which are included inside the selector 310. An address of the correction table 311 corresponding to a voltage data closest to the digitized voltage is then specified.

Alternatively, the analog voltage of the output detecting section 309 is compared with a plurality of voltage levels at the time of obtaining the correction table by a plurality of comparators, respectively. An address of the correction table 311 is then specified according to output patterns of a plurality of comparator outputs.

The correction table 311 supplies one of correction data sequences A through D represented by correction A through D by addressing from the selector 310. The correction data sequences A through D are determined as follows, for example.

Symbol A is a correction data sequence obtained as a result of evaluation in an ambient temperature, symbol B is a correction data sequence obtained as a result of evaluation at the highest temperature specified in an absolute rating, symbol C is a correction data sequence obtained as a result of evaluation at the lowest temperature specified in the absolute rating, and symbol D is a correction data sequence obtained as a result of evaluation at a temperature between the absolute rating temperature and the ambient temperature.

Each of the correction data sequences A through D records a supply voltage which should be supplied to the radio frequency power amplifier 305 and a phase rotation which should be supplied to the phase component for a signal amplitude which is desired to be produced from the radio frequency power amplifier 305. Ideally, in the radio frequency power amplifier 305, an output signal amplitude may perfectly be proportional to the supply voltage, and even when the supply voltage is changed, a phase difference between an output signal and an input signal may be constant. However, since it will not actually happen, it is required to correct the supply voltage and the phase of the input signal for the signal amplitude which is desired to be produced.

The phase-amplitude correction means 303 receives an output of the OFDM signal generating means 301, namely an amplitude and a phase of a signal which is desired to be produced from the radio frequency power amplifier 305 and obtains an output of a correction result of an OFDM signal corrected by an optimum correction table sequence of the correction table 311 which is selected by the selector 310.

The quadrature modulator 304 performs a frequency conversion of a phase component supplied from the phase-amplitude correction means 303 and obtains an output of an OFDM modulated wave.

The DC-DC converter 308 adjusts an offset voltage and an amplitude so that the amplitude component may swing between the supply voltage maximum rating of the radio frequency power amplifier 305 and 0 V with respect to the amplitude component supplied from the phase-amplitude correction means 303. It then converts a DC voltage supplied from the supply voltage 307 into an adjusted amplitude component.

The output coupling section 306 couples an RF power proportional to the output power of the radio frequency power amplifier 305 (for example, 10 dB coupling) to supply to the output detecting section 309.

In the output detecting section 309, a circuit which is composed of, for example a diode and a smoothing capacitor detects an RF power proportional to the output power of the radio frequency power amplifier 305.

The radio frequency power amplifiers 305 may be, operated at, for example class F, and a modulated wave signal supplied from the quadrature modulator 304 is supplied into a signal input terminal and subsequently amplified in power. Moreover, the amplitude component to which an voltage conversion ha been performed by the DC-DC converter 308 is supplied from a power supply terminal. As a result, the radio frequency power amplifier 305 produces an original OFDM signal modulated wave, the phase and the amplitude of which are both modulated, namely the amplitude and the phase of which are multiplied.

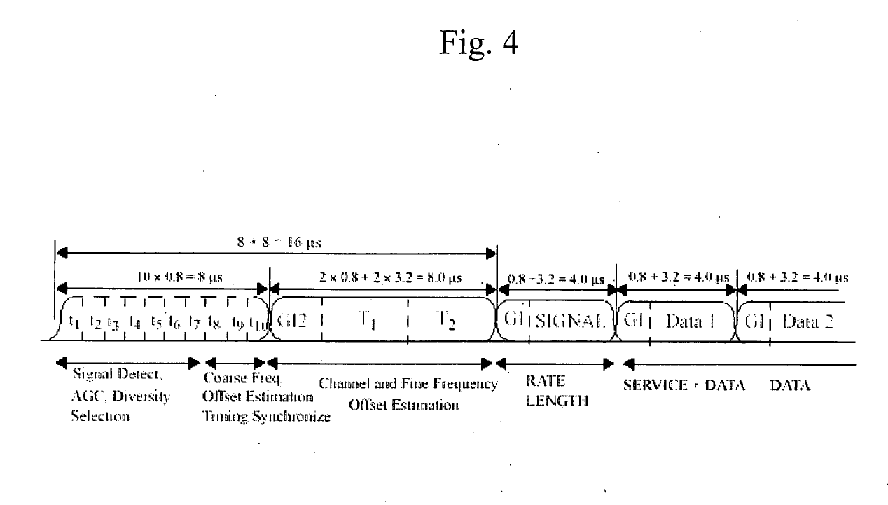

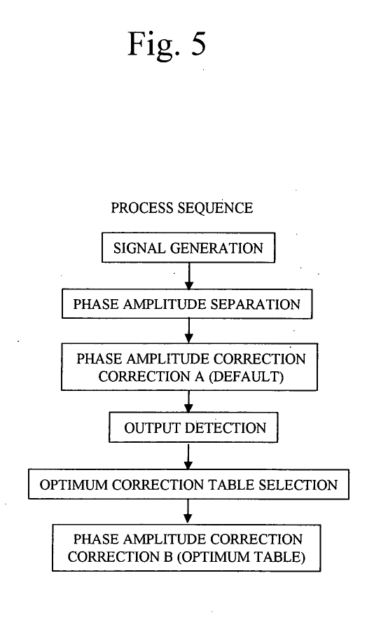

Hereinafter, description will be made of the operation using FIG. 4 and FIG. 5.

A format of a preamble signal of 802.11a used as an example is shown in FIG. 4. A preamble signal is a signal of 16 μsec of the beginning of a Burst period and signal detection, AGC, and diversity selection must be performed within 7/10 of the first 8 μsec. Therefore, it must complete within a time about 7/10 of 8 μsec until the selector 310 selects the data from the correction table 311 and the phase-amplitude correction means 303 completes the correction. In addition, the correction will be performed every Burst time.

Description will be made of a process sequence using FIG. 5. When receiving the burst SEND statement from the MAC, the OFDM signal generating means 301 supplies the OFDM modulated wave. An IQ quadrature signal of a supplied OFDM is separated into an amplitude component (amplitude modulation component) and a phase component (phase modulation component) by the phase-amplitude separation means 302 and a correction is applied to respective components of amplitude and phase by using the correction data A at the ambient temperature as a default. A corrected amplitude component is supplied to the DC-DC converter 308 and subjected to a level conversion and an amplitude adjustment, and a supply voltage is converted into an amplitude component and is supplied into a supply voltage terminal of the radio frequency power amplifier 305. On the other hand, after being subjected to a frequency conversion by the quadrature modulator 304, the phase component is supplied into a signal input terminal of the radio frequency power amplifier 305. In the radio frequency power amplifier 305, the amplitude component and the phase component are multiplied at an output to become an original OFDM-IQ modulated wave to be produced the produced IQ modulated wave is supplied into the output coupling section 306, so that a small signal, for example smaller by 10 dB, proportional to the output power of the radio frequency power amplifier 305 is taken out from the output coupling section 306.

In the output detecting section 309, the RF power taken out by the output coupling section 306 is rectified by a diode and is then smoothed by a smoothing capacitor, and produced as an average voltage of preamble time. The average voltage taken out by the output detecting section 309 is compared with output average voltages measured at various environmental temperatures of the radio frequency power amplifier 305 in advance inside the selector 310. A correction table at an environmental temperature corresponding to an output average voltage closest to the average voltage taken out by the output detecting section 306, for example the correction B is then selected from the correction table 311. These processes are completed within about 7/10 of 8 μsec and a correction result will be reflected to an OFDM signal during a subsequent burst interval.

According to a configuration described above, in the second embodiment, since the table data is selected by using the output of the radio frequency power amplifier 305, a channel temperature in operation of the radio frequency power amplifier 305 can be reflected correctly. Thereby making it possible to perform the correction of the radio frequency power amplifier 305 correctly. Moreover, since quadrature detection is not used for the output detecting section 309, a correction circuit and an algorithm can be simplified, thereby making it possible to achieve reduction in power consumption.

Moreover, according to a configuration of the present invention, the EER method can perform an accurate temperature compensation without degradation to an alternative adjacent channel power ratio.

Moreover, by using the EER method, the radio frequency power amplifier can be operated near a saturation point. Therefore, the radio frequency power amplifier can be operated at a mostly theoretical maximum drain efficiency, thereby making it possible to achieve high efficiency.

Industrial Availability

A signal transmitter of the present invention is useful in radio communications systems which require reduction in power consumption, such as a cellular phone and a wireless LAN, as an highly efficient signal transmitter.

1. A signal transmitter, comprising:
a radio frequency power amplifier into which a modulated wave signal is supplied;
RF power coupling means which exists in an output of said radio frequency power amplifier and takes out an RF power proportional to an output power of said radio frequency power amplifier;
means of detecting an output voltage of said RF power coupling means;
storage means of recording a correction datatable for applying a change to the modulated wave signal supplied into said radio frequency amplifier corresponding to an output result of said means of detecting the output voltage; and
means of applying a change to the modulated wave signal supplied into said radio frequency power amplifier with reference to corresponding correction data from said storage
means according to the output result of said means of detecting said output voltage.

2. A signal transmitter, comprising:
modulated wave signal generating means of generating at least a modulated wave signal;
phase-amplitude separation means of separating said modulated wave signal supplied from said modulated wave signal generating means into a phase component and an amplitude component as expressed on a polar coordinate;
a constant voltage source
DC-DC conversion means into which said amplitude component and an output voltage of said constant voltage source are supplied to perform a voltage conversion of the voltage of said constant voltage source to a voltage proportional to said amplitude component,
a radio frequency power amplifier which supplies said phase component into a signal input terminal thereof, supplies the output of said DC-DC conversion means into a power supply terminal thereof, and produces a resultant modulated wave which is obtained by multiplying said amplitude component by said phase component;
RF power coupling means which exists in an output of said radio frequency power amplifier and takes out an RF power proportional to an output power of said radio frequency power amplifier;
means of detecting an output voltage of said RF power coupling means;
storage means of recording a correction datatable for applying a change to the amplitude component and the phase component supplied into said radio frequency amplifier corresponding to an output result of said means of detecting the output voltage; and
means of applying a change to an output of said phase-amplitude separation means with reference to corresponding correction data from said storage means according to an output result of said means of detecting the output voltage.

3. The signal transmitter according to claim 2, further comprising frequency conversion means between said radio frequency powers amplifier and an output of the phase component of said phase-amplitude separation means.
